(19) United States
(12) Patent Application Publication
(10) Pub. No.: US 2022/0374021 A1
(43) Pub. Date: Nov. 24, 2022

(54) TRAJECTORY PLANNING DEVICE, TRAJECTORY PLANNING METHOD, AND PROGRAM

(71) Applicant: SONY GROUP CORPORATION, TOKYO (JP)

(72) Inventor: RYO TAKAHASHI, TOKYO (JP)

(21) Appl. No.: 17/755,139

(22) PCT Filed: Oct. 13, 2020
(86) PCT No.: PCT/JP2020/038558

§ 371 Date: Apr. 21, 2022

(30) Foreign Application Priority Data
Oct. 31, 2019 (JP) 2019-198426

(51) Int. Cl. G05D 1/02

(52) U.S. Cl. CPC G05D 1/0219; G05D 1/0236; G05D 1/024

(57) ABSTRACT

A potential field generation unit 161 generates a potential field in which a local minimum point is not generated in a search range by making a potential distribution of the search range for searching a trajectory toward a target point asymmetric. For example, the potential field generation unit 161 generates an integrated potential field in which a potential distribution is asymmetric by integrating an offset potential field generated using an offset function to make the potential distribution asymmetric, a trajectory potential field in which potential decreases as a distance from the target point and a shortest trajectory to the target point decreases, and an obstacle potential field in which potential decreases as a distance from an obstacle increases. A trajectory planning unit 162 sets a plurality of trajectory candidates heading for the target point within a trajectory search range of a mobile body, and sets a trajectory candidate having a minimum moving cost calculated on the basis of the integrated potential field as an optimal trajectory. A highly stable trajectory plan can be easily created.

### TECHNICAL FIELD

This technology relates to a trajectory planning device, a trajectory planning method, and a program, and enables creation of a highly stable trajectory plan.

### BACKGROUND ART

Conventionally, in a case where a mobile body such as a robot, a vehicle, and the like is autonomously operated, it is necessary to create a trajectory plan for moving to a target point while avoiding surrounding obstacles using an environmental map. For this reason, for example, in Patent Document 1, a grid point having a low potential is sequentially searched from eight grid points near a mobile body on the basis of the potential of each grid point regarding an obstacle in an environmental map, and a direction of the searched grid point is set as a moving direction, thereby creating a trajectory plan indicating the shortest trajectory to a target point.

### CITATION LIST

### Patent Document

### Patent Document 1: Japanese Patent Application Laid-Open No. 2001-154706

### SUMMARY OF THE INVENTION

### Problems to be Solved by the Invention

Meanwhile, in a case where the grid point having the low potential is sequentially searched as in Patent Document 1, if there is a plurality of grid points having minimum potential, a search needs to be performed for a plurality of moving directions, and there is a possibility that a highly stable trajectory plan cannot be easily created.

Therefore, an object of this technology is to provide a trajectory planning device, a trajectory planning method, and a program capable of easily creating a highly stable trajectory plan.

### Solutions to Problems

A first aspect of this technology is

a trajectory planning device including:

a potential field generation unit that generates a potential field in which a potential distribution in a search range for searching a trajectory toward a target point is asymmetric; and

a trajectory setting unit that sets an optimal trajectory toward the target point on the basis of the potential field generated by the potential field generation unit.

In this technology, the potential field generation unit generates the potential field in which the potential distribution in the search range for searching the trajectory toward the target point is asymmetric and no local minimum point is generated in the search range. For example, in a case where an obstacle to be avoided is recognized by object recognition, the potential field generation unit makes the potential distribution in the potential field including the obstacle to be avoided asymmetric. As processing of making the potential distribution asymmetric, for example, the potential field generation unit generates an offset potential field for making the potential distribution asymmetric using an offset function set in advance. The potential field generation unit generates a potential field in which the potential distribution is asymmetric by integrating a trajectory potential field in which potential decreases as a distance from the target point and a shortest trajectory to the target point decreases, an obstacle potential field in which potential decreases as a distance from an obstacle increases, and the offset potential field. Note that the potential field generation unit may set maximum potential at a position of the obstacle, or may set maximum potential from the position of the obstacle to a predetermined distance range in the obstacle potential field.

In a case where the obstacle to be avoided is recognized by object recognition, the potential field generation unit increases potential in a moving direction of the obstacle. Furthermore, the potential field generation unit may perform processing of making the potential distribution asymmetric on the basis of not only an obstacle recognition result but also an environmental map.

The trajectory planning unit sets the optimal trajectory toward the target point on the basis of the potential field generated by the potential field generation unit. For example, the trajectory setting unit sets a plurality of trajectory candidates heading for the target point within a trajectory search range of a mobile body, and sets the trajectory candidate having a minimum moving cost as the optimal trajectory.

A second aspect of this technology is

a trajectory planning method including:

generating, by a potential field generation unit, a potential field in which a potential distribution in a search range for searching a trajectory toward a target point is asymmetric; and

setting, by a trajectory setting unit, an optimal trajectory toward the target point on the basis of the potential field generated by the potential field generation unit.

A third aspect of this technology is

a program that causes a computer to set an optimal trajectory toward a target point,

the program that causes the computer to execute:

a procedure of generating a potential field in which a potential distribution in a search range for searching a trajectory toward the target point is asymmetric; and

a procedure of setting an optimal trajectory toward the target point on the basis of the potential field.

Note that the program of the present technology is, for example, a program that can be provided for a general-purpose computer capable of executing various program codes by a storage medium provided in a computer-readable format, or a communication medium, for example, a storage medium such as an optical disk, a magnetic disk, or a semiconductor memory, or a communication medium such as a network. By providing such a program in a computer-readable format, processing according to the program is realized on the computer.

### BRIEF DESCRIPTION OF DRAWINGS

FIG. 1 is a diagram illustrating a trajectory potential field.

FIG. 2 is a diagram illustrating an obstacle potential field.

FIG. 3 is a diagram illustrating a case where there is an obstacle on a target trajectory.

FIG. 4 is a diagram illustrating another case where there is an obstacle on a target trajectory.

FIG. 5 is a diagram illustrating a part of a configuration of a mobile body system.

FIG. 6 is a flowchart illustrating operation of a trajectory planning unit.

FIG. 7 is a diagram for explaining asymmetry.

FIG. 8 is a diagram for explaining integration of potential fields.

### MODE FOR CARRYING OUT THE INVENTION

Hereinafter, a mode for carrying out the present technology will be described. Note that the description will be given in the following order.

1. Potential used for creating trajectory plan

2. Configuration in embodiment

3. Operation in embodiment

4. Application example

<1. Potential Used for Creating Trajectory Plan>

In creating a trajectory plan, a direction in which potential is small is searched by using a potential field indicating an attractive force for pulling a mobile body toward a target point and a repulsive force for moving the mobile body away from an obstacle, and a trajectory in which a moving cost (an integrated value of potential when the mobile body moves in the trajectory) is minimized is set as an optimal trajectory. It is desirable that the mobile body move along a target trajectory, for example, a shortest trajectory connecting its own position and a target point in a case where there is no obstacle (also referred to as a “target trajectory”) and toward the target point. Therefore, in a potential field indicating an attractive force for pulling the mobile body toward the target point (hereinafter referred to as a “trajectory potential field”), potential is smaller as a distance from the target trajectory decreases, and the potential is minimized at the target point.

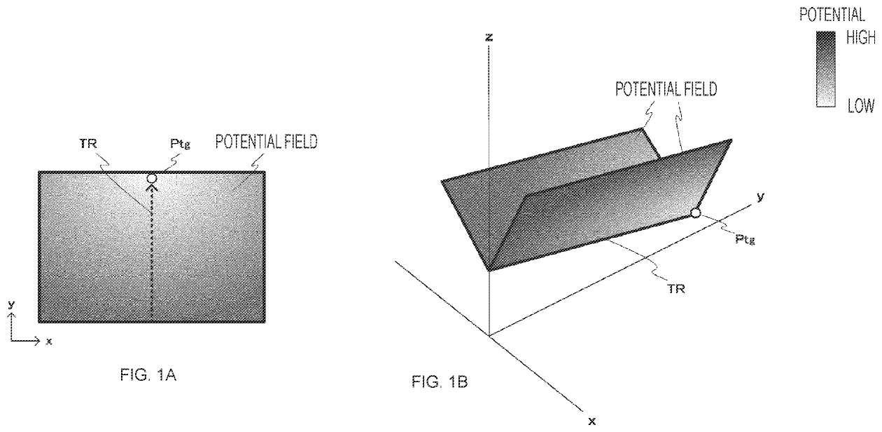

FIG. 1 illustrates a trajectory potential field. (a) of FIG. 1 illustrates a trajectory potential field in a two-dimensional space, and (b) of FIG. 1 illustrates a trajectory potential field in a three-dimensional space. In the trajectory potential field, potential is smaller as a distance from a target trajectory decreases, and the potential is minimized at a target point Ptg. By creating the trajectory potential field in this manner, a mobile body can reach the target point Ptg with a minimum moving cost by traveling in a direction in which the potential is small. Note that a broken line TR indicates a shortest trajectory toward the target point Ptg.

Furthermore, it is desirable that the mobile body move while avoiding an obstacle. Therefore, in a potential field indicating a repulsive force for moving the mobile body away from an obstacle OBr (hereinafter referred to as an “obstacle potential field”), potential is maximized at a position of the obstacle OBr, and the potential is decreased with an increase of a distance from the obstacle OBr.

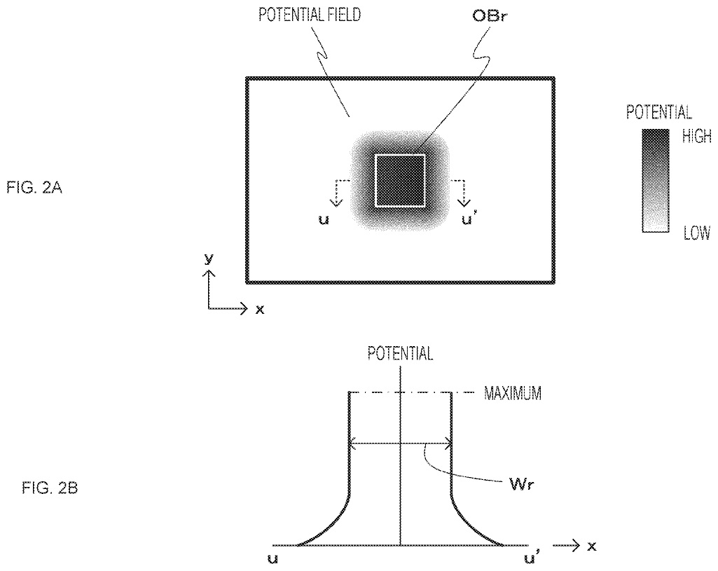

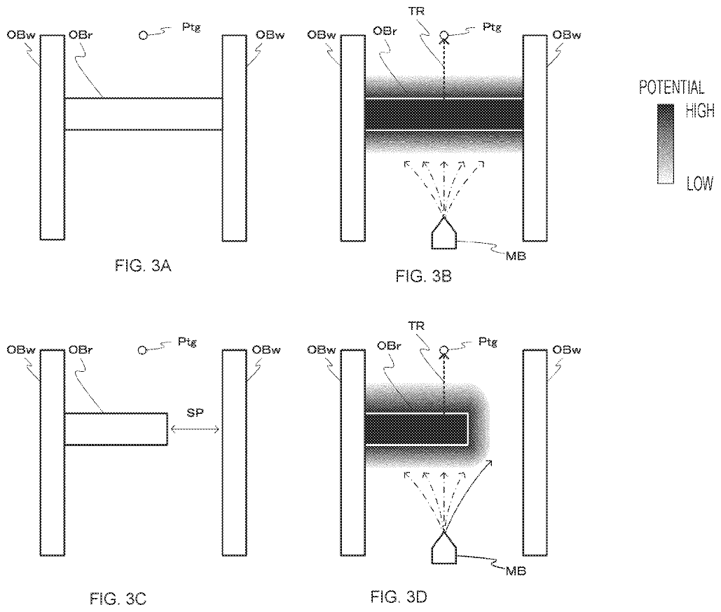

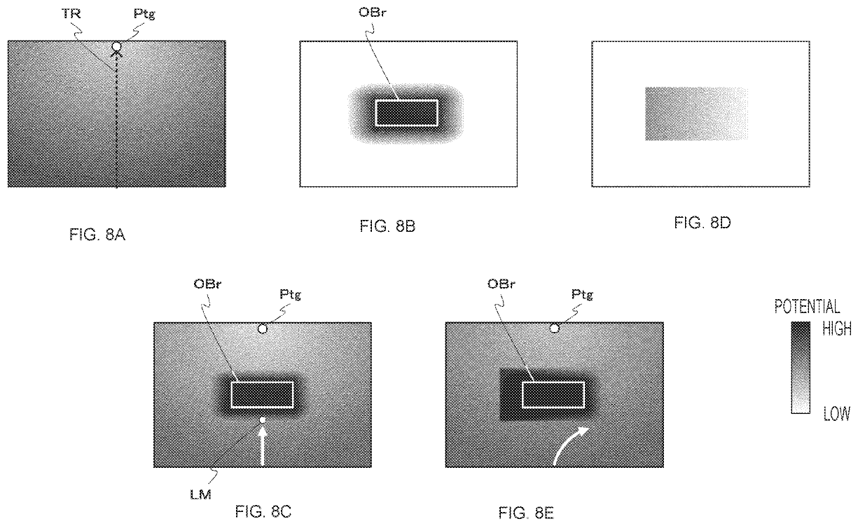

FIG. 2 illustrates an obstacle potential field. (a) of FIG. 2 illustrates an obstacle potential field in a two-dimensional plane. Furthermore, (b) of FIG. 2 illustrates a relationship between a distance from the obstacle OBr (width Wr) and potential at a position u-u′ in (a) of FIG. 2. In the obstacle potential field, the potential is maximized at a position of the obstacle OBr. Note that, in (a) of FIG. 2 and (b), (d) of FIG. 3, (b) of FIG. 4, and (b), (c), and (e) of FIG. 8 as described later, a boundary of the obstacle is indicated by a white rectangular frame so that the position of the obstacle OBr can be grasped.

FIG. 3 illustrates a case where there is an obstacle on a target trajectory. For example, as illustrated in (a) of FIG. 3, in a case where a space that allows traveling is blocked by walls OBw and the obstacle OBr, a potential field is as illustrated in (b) of FIG. 3. That is, potential is maximized even if a mobile body MB travels in any direction toward the target point Ptg as indicated by one-dot chain line arrows. Furthermore, since the potential increases if the distance from the target trajectory (for example, the shortest trajectory toward the target point Ptg) increases, the mobile body MB moves on a trajectory close to the target trajectory and then stops at a local minimum point of the potential. Note that, in (b) of FIG. 3 and (d) of FIG. 3, potential of the wall OBw is omitted. Furthermore, a broken line TR indicates the shortest trajectory toward the target point Ptg in a case where there is no obstacle OBr, and the same applies to FIGS. 4 and 8.

In a case where the obstacle OBr is small, as illustrated in (c) of FIG. 3, a space SP through which the mobile body MB can pass is generated. In this case, the potential field is as illustrated in (d) of FIG. 3. That is, the potential decreases as the distance from the obstacle OBr increases, and the potential decreases as the distance from the target trajectory decreases. Therefore, the mobile body MB travels in a direction of a solid arrow, and then avoids the obstacle OBr to reach the target point Ptg.

FIG. 4 illustrates another case where there is an obstacle on a target trajectory. As illustrated in (a) of FIG. 4, in a case where the obstacle OBr in front is large, the potential field is as illustrated in (b) of FIG. 4. Note that a space SPL, SPR through which the mobile body MB can pass is generated between the wall OBw and the obstacle OBr. Since the potential of the mobile body MB increases as the distance from the obstacle OBr decreases and the distance from the target trajectory increases, if the spaces SPL and SPR are not included in a trajectory search range SR of the mobile body MB, the mobile body MB moves on a trajectory close to the target trajectory and then stops at a local minimum point of the potential, similarly to the case illustrated in (b) of FIG. 3.

Therefore, in the present technology, by generating a potential field in which a potential distribution in a search range for searching a trajectory toward a target point is asymmetric, a local minimum point is not generated in the potential field in the search range, and an optimal trajectory toward the target point is set on the basis of this potential field.

### 2. Configuration in Embodiment

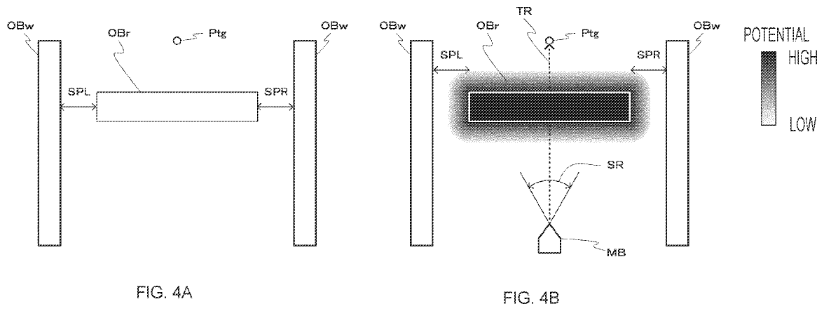

FIG. 5 illustrates a part of a configuration of a mobile body system. A mobile body system 10 includes a distance measurement sensor unit 11, an obstacle map creation unit 12, a target trajectory planning unit 13, an object recognition unit 14, a map holding unit 15, a trajectory planning unit 16, an operation control unit 17, and a drive unit 18.

The distance measurement sensor unit 11 includes a light detection and ranging laser imaging detection and ranging (LIDAR), a time of flight (TOF), a stereo camera, and the like, and measures a distance to an object (obstacle) included in a trajectory search range of a mobile body. The distance measurement sensor unit 11 outputs a distance measurement result to the obstacle map creation unit 12.

The obstacle map creation unit 12 generates map information indicating an obstacle (hereinafter referred to as “obstacle map information”) on the basis of the distance measurement result by the distance measurement sensor unit 11 and outputs the map information to the trajectory planning unit 16.

The target trajectory planning unit 13 sets, as a target trajectory, a target trajectory to a target point instructed by a user and the like, for example, the shortest trajectory to the target point in a case where there is no obstacle. The target trajectory planning unit 13 outputs target trajectory information indicating the target trajectory to the trajectory planning unit 16.

The object recognition unit 14 includes, for example, a complementary metal oxide semiconductor (CMOS) image sensor or a charge coupled device (CCD) image sensor that acquires a captured image, and a recognition unit that recognizes an object included in the captured image acquired by the image sensor. The object recognition unit 14 recognizes an object located in the periphery on the basis of the captured image, and outputs a recognition result to the trajectory planning unit 16.

The map holding unit 15 has an environmental map including a current position of the mobile body and a target point. The environmental map is used, for example, for estimation of a self-position by star reckoning, setting of a drive candidate to the target point, and the like. The map holding unit 15 outputs the held environmental map to the trajectory planning unit 16.

The trajectory planning unit 16 includes a potential field generation unit 161 and a trajectory setting unit 162. Furthermore, the potential field generation unit 161 includes an obstacle potential field generation unit 1611, a trajectory potential field generation unit 1612, an asymmetry determination unit 1613, and a potential field integration unit 1614. The trajectory setting unit 162 includes a trajectory candidate setting unit 1621 and an optimal trajectory selection unit 1622.

On the basis of the obstacle map output from the obstacle map creation unit 12, the obstacle potential field generation unit 1611 generates an obstacle potential field in which potential is maximum at a position of the obstacle and the potential decreases with an increase of a distance from the obstacle. The obstacle potential field generation unit 1611 outputs the generated obstacle potential field to the potential field integration unit 1614.

On the basis of the target trajectory output from the target trajectory planning unit 13, the trajectory potential field generation unit 1612 generates a trajectory potential field in which potential increases with an increase of a distance from the target trajectory and the potential decreases with a decrease of a distance from the target point. The trajectory potential field generation unit 1612 outputs the generated trajectory potential field to the potential field integration unit 1614.

The asymmetry determination unit 1613 determines whether asymmetry processing is necessary on the basis of the obstacle map output from the obstacle map creation unit 12, the object recognition result output from the object recognition unit 14, and the environmental map held in the map holding unit 15. The asymmetry determination unit 1613 determines an object to be avoided on the basis of the obstacle map and the object recognition result. Furthermore, the asymmetry determination unit 1613 determines whether there is a space that can move while avoiding the object to be avoided on the basis of a determination result of the object to be avoided and the maps. The asymmetry determination unit 1613 determines to perform asymmetry of the obstacle potential field in a case where there is a space that can move while avoiding the object to be avoided, and determines not to perform asymmetry in a case where there is no space that can move while avoiding the object to be avoided. The asymmetry determination unit 1613 outputs a determination result to the potential field integration unit 1614.

The potential field integration unit 1614 aligns and integrates (for example, aligns and adds potential for each grid point) the obstacle potential field generated by the obstacle potential field generation unit 1611 and the trajectory potential field generated by the trajectory potential field generation unit 1612. Furthermore, the potential field integration unit 1614 performs asymmetry of the potential field on the basis of the determination result of the asymmetry determination unit 1613. In a case where the object to be avoided that is an obstacle to be avoided is recognized, the potential field integration unit 1614 makes a potential distribution in the potential field including the object to be avoided asymmetric. In a case where the potential distribution is made asymmetric, the potential field integration unit 1614 adjusts the potential field so as not to generate a local minimum point of the potential in a trajectory search range using, for example, a preset offset function. The potential field integration unit 1614 outputs information indicating the adjusted potential field in which the potential distribution is made asymmetric to the trajectory setting unit 162.

Furthermore, in a case where the asymmetry determination unit 1613 determines not to perform asymmetry, the potential field integration unit 1614 outputs information indicating a potential field that has not been adjusted to the trajectory setting unit 162.

The trajectory candidate setting unit 1621 in the trajectory setting unit 162 sets a plurality of trajectory candidates heading for the target point within the trajectory search range of the mobile body moving on an optimal trajectory. Note that the trajectory candidate also includes the target trajectory. The trajectory candidate setting unit 1621 outputs information indicating the set trajectory candidates to the optimal trajectory selection unit 1622.

On the basis of the information output from the potential field generation unit 161, the optimal trajectory selection unit 1622 selects, as an optimal trajectory, a trajectory candidate having a minimum moving cost from among the trajectory candidates set by the trajectory candidate setting unit 1621, and outputs the selected candidate to the operation control unit 17.

The operation control unit 17 generates a drive control signal for moving the mobile body on the optimal trajectory set by the trajectory setting unit 162, and outputs the signal to the drive unit 18.

The drive unit 18 drives an actuator, wheels, and the like on the basis of the drive control signal from the operation control unit 17 to move the mobile body.

### 3. Operation in Embodiment

FIG. 6 is a flowchart illustrating operation of the trajectory planning unit. In step ST1, the trajectory planning unit generates an obstacle potential field. On the basis of an obstacle map output from the obstacle map creation unit 12, the trajectory planning unit 16 generates an obstacle potential field in which potential is maximum at a position of an obstacle and the potential decreases with an increase of a distance from the obstacle, and proceeds to step ST2.

In step ST2, the trajectory planning unit generates a trajectory potential field. On the basis of a target trajectory output from the target trajectory planning unit 13, the trajectory planning unit 16 generates a trajectory potential field in which potential increases with an increase of a distance from a target point and the target trajectory, and proceeds to step ST3.

In step ST3, the trajectory planning unit determines whether or not to perform asymmetry. The trajectory planning unit 16 determines an object to be avoided on the basis of the obstacle map output from the obstacle map creation unit 12 and an object recognition result output from the object recognition unit 14. Moreover, the trajectory planning unit 16 determines whether there is a space that can move while avoiding the object to be avoided on the basis of a determination result of the object to be avoided, the obstacle map, and an environmental map held by the map holding unit 15. In a case where there is a space that can move while avoiding the object to be avoided, the trajectory planning unit 16 determines to perform asymmetry, and proceeds to step ST4. Furthermore, in a case where there is no space that can move while avoiding the object to be avoided, the trajectory planning unit 16 determines not to perform asymmetry, and proceeds to step ST5.

In step ST4, the trajectory planning unit generates an offset potential field. The trajectory planning unit 16 generates an offset potential field for adjusting a potential field so as not to generate a local minimum point of a potential in a search range by making a potential distribution in the search range for searching a trajectory toward a target point asymmetric.

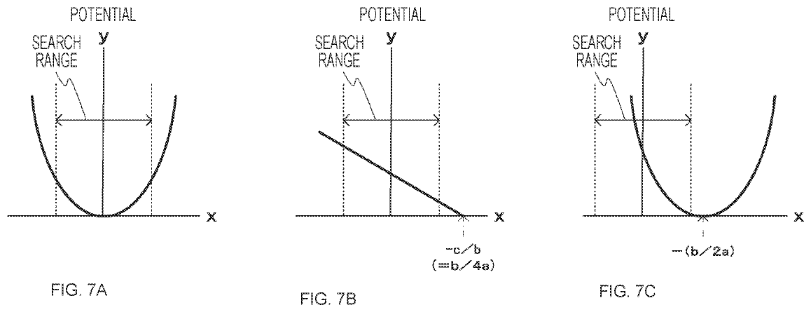

FIG. 7 is a diagram for explaining asymmetry. (a) of FIG. 7 illustrates a case where a change in the potential has, for example, a characteristic of a quadratic function illustrated in Expression (1), and a local minimum point exists in a search range for searching a trajectory.

y=ax² (1)

If the local minimum point of the potential is generated in the search range for searching the trajectory in this way, a mobile body stops at a position where the local minimum point is obtained as described above. Therefore, the trajectory planning unit 16 adds an offset potential field to a potential field exhibiting the characteristic illustrated in (a) of FIG. 7, and sets a local minimum point of a potential field after the addition as a position outside the search range. The trajectory planning unit 16 uses, for example, a linear function illustrated in Expression (2) and (b) of FIG. 7 as a function indicating a potential change of the offset potential field (also referred to as an “offset function”), and sets the potential change of the potential field after the addition as a characteristic illustrated in Expression (3) and (c) of FIG. 7. Note that in Expression (3), “c=(b²/4a)”.

y=bx+c (2)

y=a(x+(b/2a))²−(b²/4a)+c (3)

In this manner, the trajectory planning unit 16 generates the offset potential field using the offset function set in advance to cause the local minimum point to be the position outside the search range, and proceeds to step ST5.

In step ST5, the trajectory planning unit integrates the potential fields. In a case where no offset potential field is generated, the trajectory planning unit 16 generates an integrated potential field by aligning and integrating the obstacle potential field generated in step ST1 and the trajectory potential field generated in step ST2. Furthermore, in a case where the offset potential field is generated in step ST4, the trajectory planning unit 16 generates an integrated potential field by aligning and integrating the obstacle potential field generated in step ST1, the trajectory potential field generated in step ST2, and the offset potential field generated in step ST4. Note that, in the integration of the potential fields, for example, potentials at the same position in a plurality of potential fields to be integrated are added to obtain a potential of the integrated potential field.

FIG. 8 is a diagram for explaining integration of the potential fields. (a) of FIG. 8 illustrates a trajectory potential field, and (b) of FIG. 8 illustrates an obstacle potential field. Here, in a case where the trajectory potential field and the obstacle potential field are integrated, a local minimum point LM is generated on a target trajectory in an integrated potential field as illustrated in (c) of FIG. 8. However, by integrating an offset potential field illustrated in (d) of FIG. 8, it is possible to prevent generation of a local minimum point at which a mobile body stops in an integrated potential field, as illustrated in (e) of FIG. 8. The trajectory planning unit 16 integrates the plurality of potential fields, generates the integrated potential field, and proceeds to step ST6.

In step ST6, the trajectory planning unit creates trajectory candidates. The trajectory planning unit 16 sets a plurality of trajectory candidates from a position of the mobile body toward the target point within the trajectory search range of the mobile body, and proceeds to step ST7.

In step ST7, the trajectory planning unit selects an optimal trajectory. The trajectory planning unit 16 calculates a moving cost to the target point using the integrated potential field generated in step ST5 for each trajectory candidate created in step ST6. Furthermore, the trajectory planning unit 16 selects, as the optimal trajectory, a trajectory candidate having a minimum calculated moving cost. For example, in a case where the integrated potential field illustrated in (e) of FIG. 8 is generated, it is possible to set a trajectory for traveling to the target point Ptg while avoiding the obstacle OBr as indicated by a white line arrow.

Note that it is sufficient if the processing of steps ST1 and ST2 is performed before the processing of step ST5, and is sufficient if the processing of step ST6 is performed before the processing of step ST7, and is not limited to the order illustrated in FIG. 6. Furthermore, the trajectory planning unit is not limited to order processing of performing the processing in the order of steps, and the processing of steps ST1 and ST2 or the processing of steps ST1, ST2, and ST6 may be performed in parallel. In this case, the optimal trajectory can be set more quickly than a case where the processing is performed in the order of steps.

Furthermore, in FIG. 8, in a case where there is a space that can move while avoiding the object to be avoided, the offset potential field is generated and integrated with the obstacle potential field and the trajectory potential field. However, instead of generating the offset potential field, the trajectory planning unit 16 may adjust the potential of at least one of the obstacle potential field or the trajectory potential field so as not to generate a local minimum point of the potential in the search range in the integrated potential field. Furthermore, the trajectory planning unit 16 may adjust the potential of the integrated potential field generated by integrating the obstacle potential field and the trajectory potential field so as not to generate a local minimum point of the potential within the range.

As described above, in the present technology, the potential field in which the local minimum point is not included in the search range is generated by the asymmetry of the potential distribution, and the optimal trajectory is set on the basis of this potential field, so that a highly stable trajectory plan can be easily created. Furthermore, for example, if a Laplace potential method is used, it is possible to prevent generation of a local minimum point in the potential field, but there is a possibility that it takes time to calculate the potential field and it is difficult to perform movement control in real time. However, according to the present technology, since the potential distribution is made asymmetric and the optimal trajectory can be set on the basis of this asymmetric potential field, the optimal trajectory can be set more quickly than the Laplace potential method, and the movement control can be performed in real time. Furthermore, for example, even if the trajectory search range of the mobile body is not expanded to include the spaces SPL and SPR illustrated in FIG. 4, the optimal trajectory can be set on the basis of the asymmetric potential field. Therefore, it is not necessary to expand the trajectory search range to calculate moving costs of many trajectory candidates, and the optimal trajectory can be quickly set.

Furthermore, in the above-described embodiment, the case where the mobile body moves toward the target point on the two-dimensional plane has been exemplified. However, if the potential field is made asymmetric as described above in a three-dimensional space, even in a case where the mobile body moves toward a target point in the three-dimensional space, an optimal trajectory can be set and movement control can be performed in real time.

Furthermore, whether or not to make the potential distribution asymmetric may be determined on the basis of the environmental map. For example, in a case where the trajectory planning unit determines that a passage has a passable width on the basis of the environmental map, the potential distribution may be made asymmetric. Furthermore, the trajectory planning unit may switch the offset function according to movement of the obstacle to be avoided. For example, since there is a possibility that a space is narrowed in a traveling direction of the obstacle, the offset function may be switched so as to generate an offset potential field in which potential is high in the traveling direction of the obstacle and the potential is low in a direction opposite to the traveling direction. Moreover, the trajectory planning unit may randomly switch the potential of the obstacle potential field or the offset potential field so that the local minimum point of the potential does not become a fixed position, and advance the mobile body toward the target point.

Moreover, the obstacle potential field is not limited to the case where the potential decreases with the increase of the distance from the obstacle as illustrated in (b) of FIG. 2, and potential from the obstacle to a predetermined distance range may be set as a maximum value and the potential may be decreased with an increase of a distance from the predetermined distance range. In this case, it is possible to move the mobile body toward the target point while securing a predetermined clearance with respect to the obstacle, or to move the mobile body toward the target point without contacting the obstacle even if a detection result of the obstacle varies. Furthermore, if the predetermined distance range is set in advance according to a size of the mobile body, even if the mobile body side does not consider its own size, posture, and the like, it is possible to move the mobile body toward the target point without contacting the obstacle.

### 4. Application Example

The technology according to the present disclosure can be applied to various fields. For example, the technology according to the present disclosure may be realized as a device mounted on any type of a mobile body such as an automobile, an electric vehicle, a hybrid electric vehicle, a motorcycle, a bicycle, a personal mobility, an airplane, a drone, a ship, a robot, and the like. Furthermore, it may be realized as a device mounted on equipment used in a production process in a factory. If applied to such a field, a highly stable trajectory plan can be easily created, and thus, for example, automatic driving and the like can be more safely performed.

The series of processing described in the specification can be executed by hardware, software, or a combined configuration of both. In a case where processing by software is executed, a program in which a processing sequence is recorded is installed and executed in a memory in a computer incorporated in dedicated hardware. Alternatively, the program can be installed and executed on a general-purpose computer capable of executing various processing.

For example, the program can be recorded in advance on a hard disk, a solid state drive (SSD), or a read only memory (ROM) as a recording medium. Alternatively, the program can be temporarily or permanently stored (recorded) on a removable recording medium such as a flexible disk, a compact disc read only memory (CD-ROM), a magneto optical (MO) disk, a digital versatile disc (DVD), a Blu-ray Disc (BD) (registered trademark), a magnetic disk, a semiconductor memory card, and the like. Such a removable recording medium can be provided as so-called package software.

Furthermore, in addition to installing the program from the removable recording medium to the computer, the program may be transferred from a download site to the computer wirelessly or by wire via a network such as a local area network (LAN), the Internet, and the like. The computer can receive the program transferred in this way and install it on a recording medium such as a built-in hard disk and the like.

Note that the effects described in the present specification are illustration to the last and are not limited, and there may be additional effects which are not described. Furthermore, the present technology should not be construed as being limited to the embodiment of the technology described above. The embodiment of the present technology discloses the present technology in the form of an example, and it is obvious that those skilled in the art can make modifications and substitutions of the embodiment without departing from the gist of the present technology. In other words, the scope of the claims should be considered in order to determine the gist of the present technology.

Furthermore, the trajectory planning device according to the present technology may have the following configurations.

(1) A trajectory planning device including: a potential field generation unit that generates a potential field in which a potential distribution in a search range for searching a trajectory toward a target point is asymmetric; and a trajectory setting unit that sets an optimal trajectory toward the target point on the basis of the potential field generated by the potential field generation unit.

(2) The trajectory planning device according to (1), in which the potential field generation unit generates the potential field in which no local minimum point is generated in the search range.

(3) The trajectory planning device according to (1) or (2), in which the potential field generation unit makes the potential distribution asymmetric using an offset function set in advance.

(4) The trajectory planning device according to (3), in which the potential field generation unit generates an offset potential field for making the potential distribution asymmetric using the offset function.

(5) The trajectory planning device according to any one of (1) to (4), in which the potential field generation unit generates a potential field in which the potential distribution is asymmetric by integrating a trajectory potential field in which potential decreases as a distance from the target point and a shortest trajectory to the target point decreases, an obstacle potential field in which potential decreases as a distance from an obstacle increases, and the offset potential field.

(6) The trajectory planning device according to (5), in which the potential field generation unit sets maximum potential at a position of the obstacle in the obstacle potential field.

(7) The trajectory planning device according to (6), in which the potential field generation unit sets maximum potential from the obstacle to a predetermined distance range in the obstacle potential field.

(8) The trajectory planning device according to any one of (1) to (7), in which in a case where an obstacle to be avoided is recognized by object recognition, the potential field generation unit makes the potential distribution in the potential field including the obstacle to be avoided asymmetric.

(9) The trajectory planning device according to (8), in which the potential field generation unit increases potential in a moving direction of the obstacle.

(10) The trajectory planning device according to (1), in which the potential field generation unit performs processing of making the potential distribution asymmetric on the basis of an environmental map.

(11) The trajectory planning device according to any one of (1) to (10), in which the trajectory setting unit sets a plurality of trajectory candidates heading for the target point, and sets the trajectory candidate having a minimum moving cost as the optimal trajectory.

(12) The trajectory planning device according to any one of (1) to (11), in which the trajectory setting unit sets the trajectory candidate within a trajectory search range of a mobile body that moves on the optimal trajectory.

### REFERENCE SIGNS LIST

10 Mobile body system
11 Distance measurement sensor unit
12 Obstacle map creation unit
13 Target trajectory planning unit
14 Object recognition unit
15 Map holding unit
16 Trajectory planning unit
17 Operation control unit
18 Drive unit
161 Potential field generation unit
162 Trajectory setting unit
1611 Obstacle potential field generation unit
1612 Trajectory potential field generation unit
1613 Asymmetry determination unit
1614 Potential field integration unit
1621 Trajectory candidate setting unit
1622 Optimal trajectory selection unit

1. A trajectory planning device comprising:
a potential field generation unit that generates a potential field in which a potential distribution in a search range for searching a trajectory toward a target point is asymmetric; and
a trajectory setting unit that sets an optimal trajectory toward the target point on a basis of the potential field generated by the potential field generation unit.

2. The trajectory planning device according to claim 1,
wherein the potential field generation unit generates the potential field in which no local minimum point is generated in the search range.

3. The trajectory planning device according to claim 1,
wherein the potential field generation unit makes the potential distribution asymmetric using an offset function set in advance.

4. The trajectory planning device according to claim 3,
wherein the potential field generation unit generates an offset potential field for making the potential distribution asymmetric using the offset function.

5. The trajectory planning device according to claim 1,
wherein the potential field generation unit generates a potential field in which the potential distribution is asymmetric by integrating a trajectory potential field in which potential decreases as a distance from the target point and a shortest trajectory to the target point decreases, an obstacle potential field in which potential decreases as a distance from an obstacle increases, and the offset potential field.

6. The trajectory planning device according to claim 5,
wherein the potential field generation unit sets maximum potential at a position of the obstacle in the obstacle potential field.

7. The trajectory planning device according to claim 6,
wherein the potential field generation unit sets maximum potential from the obstacle to a predetermined distance range in the obstacle potential field.

8. The trajectory planning device according to claim 1,
wherein in a case where an obstacle to be avoided is recognized by object recognition, the potential field generation unit makes the potential distribution in the potential field including the obstacle to be avoided asymmetric.

9. The trajectory planning device according to claim 8,
wherein the potential field generation unit increases potential in a moving direction of the obstacle.

10. The trajectory planning device according to claim 1,
wherein the potential field generation unit performs processing of making the potential distribution asymmetric on a basis of an environmental map.

11. The trajectory planning device according to claim 1,
wherein the trajectory setting unit sets a plurality of trajectory candidates heading for the target point, and sets the trajectory candidate having a minimum moving cost as the optimal trajectory.

12. The trajectory planning device according to claim 1,
wherein the trajectory setting unit sets the trajectory candidate within a trajectory search range of a mobile body that moves on the optimal trajectory.

13. A trajectory planning method comprising:
generating, by a potential field generation unit, a potential field in which a potential distribution in a search range for searching a trajectory toward a target point is asymmetric; and
setting, by a trajectory setting unit, an optimal trajectory toward the target point on a basis of the potential field generated by the potential field generation unit.

14. A program that causes a computer to set an optimal trajectory toward a target point,
the program that causes the computer to execute:
a procedure of generating a potential field in which a potential distribution in a search range for searching a trajectory toward the target point is asymmetric; and
a procedure of setting an optimal trajectory toward the target point on a basis of the potential field.
